(19) United States
(12) Patent Application Publication
(10) Pub. No.: US 2026/0119608 A1
(43) Pub. Date: Apr. 30, 2026

(54) ELECTRONIC DEVICE AND METHOD OF OPERATING THE SAME

(71) Applicant: SAMSUNG ELECTRONICS CO., LTD., Suwon-si (KR)

(72) Inventors: Backki KIM, Suwon-si (KR); Dongha BAHN, Suwon-si (KR); Byungkwon KANG, Suwon-si (KR)

(21) Appl. No.: 19/378,740

(22) Filed: Nov. 4, 2025

Related U.S. Application Data
(63) Continuation of application No. PCT/KR2025/016463, filed on Oct. 17, 2025.

(30) Foreign Application Priority Data
Oct. 29, 2024 (KR) 10-2024-0149924

(51) Int. Cl. G06F 18/2113; G06F 18/22; G06F 18/23213

(52) U.S. Cl. CPC G06F 18/2113; G06F 18/22; G06F 18/23213

(57) ABSTRACT

An electronic device includes: memory storing one or more instructions, and at least one processor, comprising processing circuitry, wherein at least one processor, individually and/or collectively, is configured to execute the instructions and to cause the electronic device to: obtain a cluster including a plurality of feature vectors, in which a specified number of guide point feature vectors are defined from among the plurality of feature vectors and the feature vectors are arranged in order of feature vectors adjacent to each guide point feature vector, obtain a target feature vector corresponding to queried input data, identify a first guide point feature vector corresponding to the target feature vector, and obtain a resultant feature vector by searching the feature vectors in order of the feature vectors adjacent to the first guide point feature vector.

### CROSS-REFERENCE TO RELATED APPLICATIONS

This application is a continuation of International Application No. PCT/KR2025/016463 designating the United States, filed on October 17, 2025, in the Korean Intellectual Property Receiving Office and claiming priority to Korean Patent Application No. 10-2024-0149924, filed on October 29, 2024, in the Korean Intellectual Property Office, the disclosures of each of which are incorporated by reference herein in their entireties.

### BACKGROUND

### Field

The disclosure relates to an electronic device and a method of operating the electronic device, and for example, to an electronic device for an efficient vector search and a method of operating the electronic device.

### Description of the Related Art

Vector search has an important role in modern computing environments, and particularly, has an even increased significance in on-device artificial intelligence (AI) applications. Such applications prefer on-device processing to cloud-based processing for the sake of protection of user's personal information, requirements of real-time processing, limited connectivity, etc. The vector search is an important function in various AI operations, such as natural language processing, image recognition, a personalization recommendation system, etc. These operations require a high-speed searching process for nearest neighbors with respect to a large amount of data. Thus, the importance of an efficient vector search algorithm further increases in the on-device AI environments.

### SUMMARY

According to an example embodiment of the disclosure, an electronic device may include memory storing one or more instructions and at least one processor comprising processing circuitry.

According to an example embodiment of the disclosure, at least one processor, individually and/or collectively, may be configured to execute the one or more instructions and cause the electronic device to: obtain a cluster including a plurality of feature vectors, in which a specified number of guide point feature vectors are defined from among the plurality of feature vectors and the feature vectors are arranged in order of feature vectors adjacent to each guide point feature vector; obtain a target feature vector corresponding to queried input data; identify a first guide point feature vector corresponding to the target feature vector; and obtain a resultant feature vector by searching the feature vectors in order of the feature vectors adjacent to the first guide point feature vector.

According to an example embodiment of the disclosure, a method of operating an electronic device may include: obtaining a cluster including a plurality of feature vectors, in which a specified number of guide point feature vectors are defined from among the plurality of feature vectors and the feature vectors are arranged in order of feature vectors adjacent to each guide point feature vector; obtaining a target feature vector corresponding to queried input data; identifying a first guide point feature vector corresponding to the target feature vector; and obtaining a resultant feature vector by searching the feature vectors in order of the feature vectors adjacent to the first guide point feature vector.

According to an example embodiment of the disclosure, a non-transitory computer-readable recording medium may have stored therein one or more instructions which, when executed by at least one processor, comprising processing circuitry, individually and/or collectively, of an electronic device, cause the electronic device to: obtain a cluster including a plurality of feature vectors, in which a specified number of guide point feature vectors are defined from among the plurality of feature vectors and the feature vectors are arranged in order of feature vectors adjacent to each guide point feature vector, obtain a target feature vector corresponding to queried input data, identify a first guide point feature vector corresponding to the target feature vector, and obtain a resultant feature vector by searching the feature vectors in order of the feature vectors adjacent to the first guide point feature vector.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a diagram describing an example operation of an electronic device according to various embodiments;

FIG. 2 is a block diagram illustrating an example configuration of an electronic device according to various embodiments;

FIG. 3 is a block diagram illustrating an example configuration of an electronic device according to various embodiments;

FIG. 4 is a diagram describing an example arrangement of feature vector stored in a storage according to various embodiments;

FIG. 5 is a diagram describing an example search method using a guide point feature vector according to various embodiments;

FIG. 6 is a flowchart illustrating an example method of operating an electronic device according to various embodiments;

FIG. 7 is a diagram illustrating an example of a feature vector space according to various embodiments;

FIG. 8 is a diagram illustrating an example method of designating a guide point in a cluster according to various embodiments

FIG. 9 is a diagram illustrating feature vectors near to a guide point according to various embodiments;

FIG. 10 is a diagram illustrating an example of a feature vector file stored in a storage according to various embodiments;

FIG. 11 is a diagram illustrating an example of a feature vector file stored in a storage according to various embodiments;

FIG. 12 is a flowchart illustrating an example method of searching feature vectors based on a guide point according to various embodiments;

FIG. 13 is a diagram illustrating an example of a block loaded on a memory from a file according to various embodiments; and

FIG. 14 is a diagram illustrating an example of a block loaded on a memory from a file according to various embodiments.

### DETAILED DESCRIPTION

The terms used in this disclosure will be briefly described and then the disclosure will be described in greater detail.

The terms used in the disclosure are general terms as possible that have been widely used nowadays in consideration of the functions in the disclosure, which, however, may be changed according to an intention of a technician in the art, a precedent, the advent of new technologies, or the like. In some cases, there may be arbitrarily selected terms, and in this case, the meanings of the terms will be described in detail in the corresponding parts of the description of the disclosure. Therefore, the terms used in the disclosure should be defined based on the meanings of the terms and the content throughout the disclosure, rather than simply based on the titles of the terms.

Throughout the disclosure, when a part "includes" or "comprises" an element, the part may further include other elements, rather than excluding the other elements, unless there is a particular description contrary thereto. Also, terms such as "unit," "module," etc., described in the disclosure indicate a unit that processes at least one function or operation, and the unit may be embodied in a hardware manner, a software manner, or a combination of the hardware manner and the software manner.

Throughout the disclosure, the expression "at least one of a, b or c" may indicate "a," "b," "c," "a and b," "a and c," "b and c," "all of a, b, and c," or variations thereof.

Hereinafter, various example embodiments of the disclosure will be described in greater detail with reference to the accompanying drawings. However, the disclosure may have different forms and should not be construed as being limited to the various embodiments of the disclosure described herein. In the drawings, parts not related to descriptions may be omitted for the clear description of the disclosure, and throughout the disclosure, like reference numerals are used for like elements.

The term "user" in the present disclosure may denote a person controlling a function or an operation of a computing device or an electronic device using a controller and may also denote a viewer, a manager, or an installing technician.

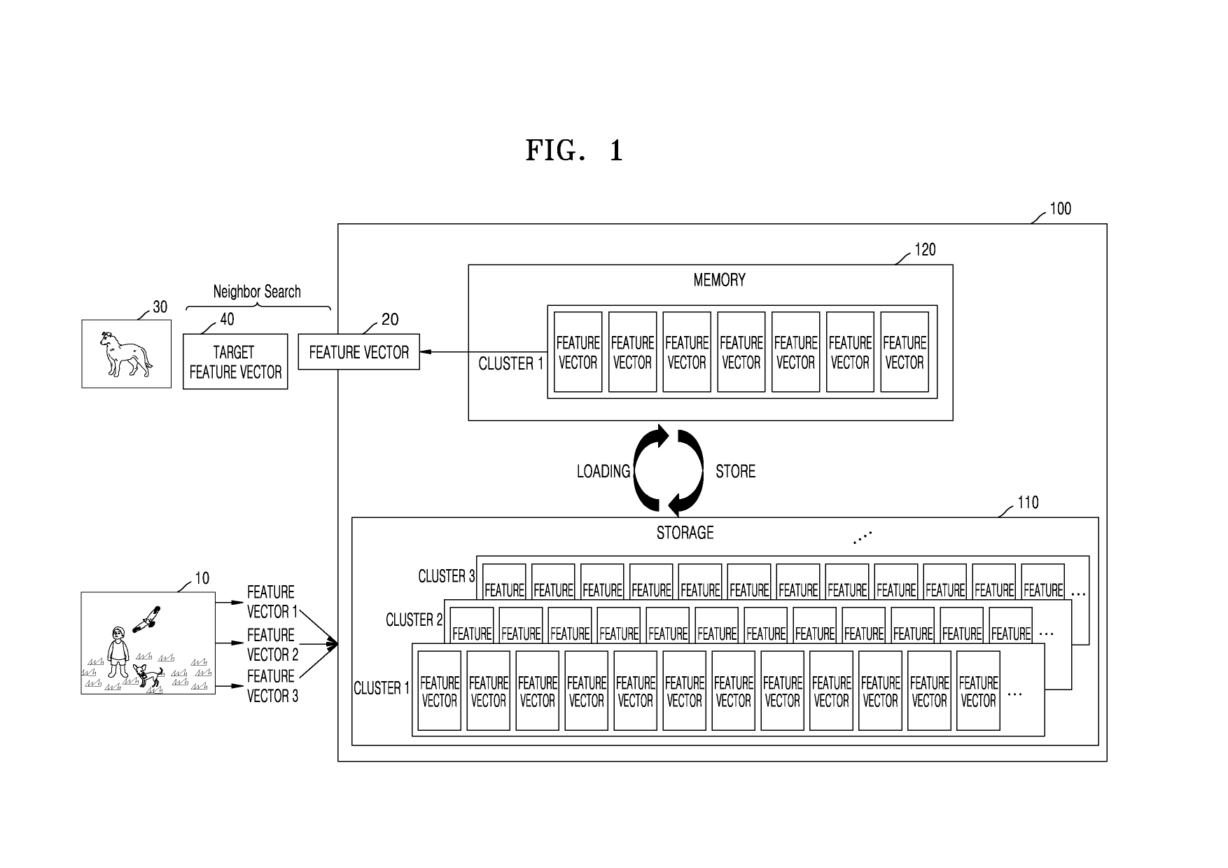

FIG. 1 is a diagram for describing an example operation of an electronic device 100 according to various embodiments.

Referring to FIG. 1, a user application of the electronic device 100 may extract a feature from an image and may thus extract a feature vector 20 corresponding to each of objects included in the image. For example, the user application may extract a feature from a photo of people and may thus extract the feature vector 20 corresponding to a face of each person in the photo. Each feature vector 20 may be designated a tag or a label for identifying the person corresponding to each face. The electronic device 100 may store a set of feature vectors designated labels in the storage (e.g., a memory) 110 by generating and/or updating inner indices of the feature vectors designated the labels. The set of the feature vectors may be clustered into units of a similar characteristic and may be stored as one or more separate clusters.

When a user application subsequently obtains a new photo 30 including a person to be identified by the application, the user application may extract a feature with respect to the new photo 30 and may thus extract a target feature vector 40 corresponding to a face of the person in the new photo 30. The user application may perform a query for requesting a determination of a corresponding label with respect to the target feature vector 40.

The electronic device 100 may perform classification on the target feature vector 40 and may determine the corresponding label. For example, the target feature vector 40 may be classified using a nearest neighbor search. The nearest neighbor search may be used for an operation of searching for an object most similar to a target data object, based on a Euclid distance between corresponding feature vectors by searching a pre-processed data object set. For example, the nearest neighbor search may be performed on a set of feature vectors to which labels are designated, the labels indicating objects extracted from visual data, so as to search for an object most similar to a feature vector extracted from recently captured visual data and not designated a label. Based on this method, the object represented by a feature vector to which a label is not designated may

be identified based on a label of a feature vector to which the most similar label is designated. The electronic device 100 may return the label corresponding to the target feature vector 40 in response to the query by the user application.

In this case, in order to identify the label corresponding to the target feature vector 40 or to search for feature vectors near to the target feature vector 40 as described above, the electronic device 100 may have to search feature vectors included in all clusters stored in the storage 110. For example, the electronic device 100 may load, on the memory 120, the feature vectors corresponding to a block size determined with respect to all clusters stored in the storage 100, and determine a degree of similarity between each of the loaded feature vectors and the target feature vector. In this case, the electronic device 100 may have to perform this operation on the feature vectors included in all clusters stored in the storage 100. Thus, it may take much time to load the feature vectors stored in the storage 110 on the memory 120, and it may be needed to calculate the degree of similarity with respect to all feature vectors, and thus, a lot of processing resources and time may be consumed.

Therefore, various embodiments of the disclosure provide an electronic device and a method of operating the same for searching feature vectors included in clusters included in a search space in a specified order, rather than searching the feature vectors of the clusters according to an arbitrary order, thereby searching for satisfactory resultant vectors without searching all of feature vectors.

According to an embodiment of the disclosure, the electronic device may obtain a cluster including a plurality of feature vectors, in which a specified number of guide point feature vectors are defined from among the plurality of feature vectors and the feature vectors are arranged in order of feature vectors adjacent to each guide point feature vector.

According to an embodiment of the disclosure, the electronic device may obtain a target feature vector corresponding to queried input data, identify a first guide point feature vector corresponding to the target feature vector, and obtain a resultant feature vector by searching the feature vectors in order of the feature vectors adjacent to the first guide point feature vector.

According to an embodiment of the disclosure, the electronic device may designate a specified number of feature vectors farthest from a center of the cluster as the guide point feature vectors and align the feature vectors within the cluster in order of distance from the guide point feature vector and record the aligned feature vectors in a storage.

According to an embodiment of the disclosure, the electronic device may split a feature vector space into a specified number of regions, based on a center of the feature vector space of the cluster and designate one guide point feature vector to each of the specified number of regions.

According to an embodiment of the disclosure, the electronic device may load, from the storage, on the memory, a block of the feature vectors in units of a specified block size, in order of the feature vectors adjacent to the guide point feature vector, and obtain one or more feature vectors adjacent to the target feature vector, by calculating degrees of similarity between the feature vectors and the target feature vector, in order of the feature vectors adjacent to the guide point feature vector in the loaded block.

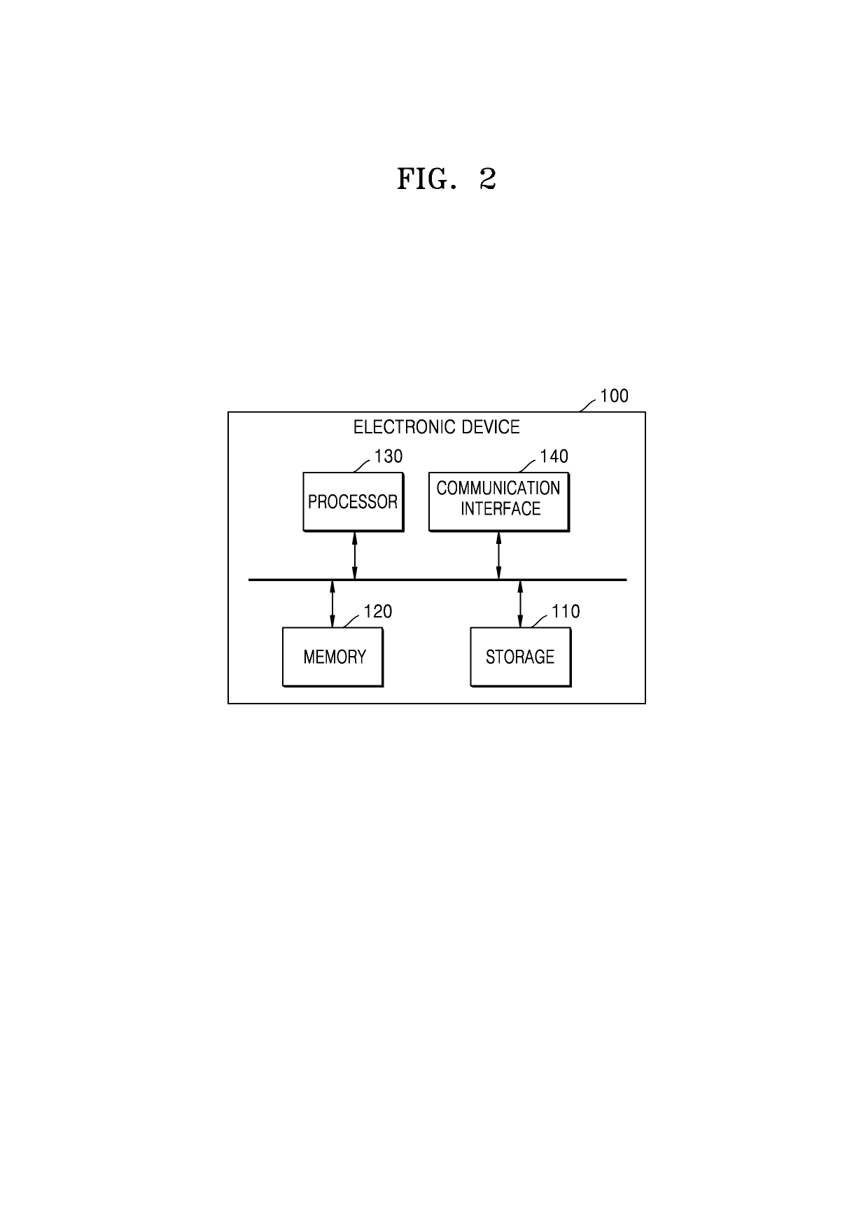

FIG. 2 is a block diagram illustrating an example configuration of the electronic device according to various embodiments.

Referring to FIG. 2, the electronic device 100 may include the storage 110, the memory 120, a processor (e.g., including processing circuitry) 130, and a communication interface (e.g., including communication circuitry) 140.

The storage 110 may include all types of devices for storing data. For example, the storage 110 may include a permanent storage device (for example, a hard disk drive (HDD), a solid state drive (SSD), or a distributed file system) capable of continually storing data.

According to an embodiment of the disclosure, the storage 110 may include a feature vector index. The feature vector index may include a representation of a feature space with respect to a particular feature vector set, and this feature vector index may be used to manage access to a feature vector in an efficient way. For example, each feature vector may be a vector including n number values respectively indicating unique features with respect to one or more data sets. For example, according to various embodiments of the disclosure, the feature vector set may include a high dimensional feature vector used to indicate information included in visual data such as an object or an operation included in an image or a video. However, according to an embodiment of the disclosure, the feature vector set may be used to indicate information related to all types of data, and the feature vector may include a dimension of an arbitrary number.

The memory 120 may store a program for processing and controlling by the processor 130 and may store data input to the electronic device 100 or output from the electronic device 100. Also, the memory 120 may store data required for operations of the electronic device 100.

The memory 120 may include at least one type of storage medium from among a flash memory type, a hard disk type, a multimedia card micro type, a card type memory (e.g., an SD or an XD memory), random-access memory (RAM), static RAM (SRAM), read-only memory (ROM), electrically erasable programmable ROM (EEPROM), programmable ROM (PROM), a magnetic memory, a magnetic disk, and an optical disk.

The processor 130 may include various processing circuitry and control the overall operations of the electronic device 100. For example, the processor 130 may be configured to execute one or more instructions stored in the memory 120 to perform the function of the electronic device 100 described in this disclosure.

The processor 130 may include various processing circuits and/or a plurality of processors. For example, the term "processor" used herein including the claims may include one or more processors and various processing circuits. At least one of the one or more processors may be configured to perform various functions described herein, separately in a distributed fashion and/or collectively. As used herein, a "processor," "at least one processor," and "one or more processors" may be configured to perform a plurality of functions. However, these terms may, for example, cover a situation in which one processor may perform some functions and (an)other processor(s) may perform the rest functions and a situation in which a single processor may perform all functions, but they are not limited thereto. Also, the at least one processor may include a combination of processors configured to perform various functions from among the functions described herein in a distributed fashion. The at least one processor may be configured to execute program instructions to achieve or perform various functions.

According to an embodiment of the disclosure, the processor 130 may store one or more instructions in an internal memory provided in the processor 130 and may be configured to execute the one or more instructions stored in the internal memory to control the operations of the electronic device 100 to be performed. That is, the processor 130 may be configured to execute one or more instructions or programs stored in the internal memory of the processor 130 or the memory 120 to perform specified operations.

According to an embodiment of the disclosure, the processor 130 may be configured to execute the one or more instructions stored in the memory 120 to perform the operations of the electronic device 100 described in this disclosure.

According to an embodiment of the disclosure, the at least one processor 130 may be configured to execute the one or more instructions stored in the memory 120 to obtain a cluster including a plurality of feature vectors, in which a specified number of guide point feature vectors are defined from among the plurality of feature vectors and the feature vectors are arranged in order of feature vectors adjacent to each guide point feature vector, obtain a target feature vector corresponding to queried input data, identify a first guide point feature vector corresponding to the target feature vector, and obtain a resultant feature vector by searching the feature vectors in order of the feature vectors adjacent to the first guide point feature vector.

According to an embodiment of the disclosure, the at least one processor 130 may be configured to execute the one or more instructions stored in the memory 120 to designate a specified number of feature vectors farthest from a center of the cluster as the guide point feature vectors, and align the feature vectors within the cluster in order of distance from the guide point feature vector and record the aligned feature vectors in a storage 110.

According to an embodiment of the disclosure, the at least one processor 130 may be configured to execute the one or more instructions stored in the memory 120 to split a feature vector space into a specified number of regions, based on a center of the feature vector space of the cluster and designate one guide point feature vector to each of the specified number of regions.

According to an embodiment of the disclosure, the at least one processor 130 may be configured to execute the one or more instructions stored in the memory 120 to load, from the storage, on the memory, a block of the feature vectors in units of a specified block size, in order of the feature vectors adjacent to the guide point feature vector, and obtain one or more feature vectors adjacent to the target feature vector, by calculating degrees of similarity between the feature vectors and the target feature vector, in order of the feature vectors adjacent to the guide point feature vector in the loaded block.

The communication interface 140 may include various communication circuits for performing communication with an external device. Here, the "communication" may denote an operation of transmitting and/or receiving data, a signal, a request, and/or a command.

For example, the communication interface 140 may include at least one of a communication module, a communication circuit, a communication device, an input/output port, and/or an input/output plug for performing wired communication with an external device.

For example, the communication interface 140 may include at least one wireless communication module, wireless communication circuit, or wireless communication device for performing wireless communication with an external device.

For example, the communication interface 140 may include a short-range wireless communication module, for example, an infrared (IR) communication module, etc., which may receive a control command from a remote controller in a short range distance, for example, an input device. In this case, the communication interface 140 may receive a control signal from the remote controller.

For example, the communication interface 140 may include at least one communication module for performing communication according to the wireless communication standards, such as Bluetooth, WiFi, Bluetooth low energy (BLE), near-field communication (NFC)/radio-frequency identification (RFID), WiFi-direct, ultra-wide band (UWB), or Zigbee. The communication interface 140 may further include a communication module for performing communication with a server configured to support remote communication according to the remote communication standards. For example, the communication interface 140 may include a communication module for performing communication through a network for Internet communication. Also, the communication interface 140 may include a communication module for performing communication through a communication network according to the communication standards, such as the 3^{rd} generation (3G), the 4^{th} generation (4G), the 5^{th} generation (5G), and/or the 6^{th} generation (6G).

For example, the communication interface 140 may include at least one port to be connected with an external device through a wired cable, in order to communicate with the external device in a wired manner. For example, the communication interface 140 may include at least one of a high-definition multimedia interface (HDMI) port, a component jack, a personal computer (PC) port, a display port, or a universal serial bus (USB) port. Thus, the communication interface 140 may perform communication with an external device connected thereto in a wired manner, through the at least one port. Here, the port may refer to a physical component to or into which a cable, a communication line, or a plug may be connected or inserted.

As described above, the communication interface 140 may include one or more one supporting elements for supporting communication with an external device. Here, the supporting elements may include the communication module, the communication circuit, the communication device, the port (for inputting/outputting data), the cable port (for inputting/outputting data), the plug (for inputting/outputting data), etc., described above. For example, the one or more supporting elements included in the communication interface 140 may include, for example, an Ethernet communication module, a WiFi communication module, a Bluetooth communication module, an IR communication module, a USB port, a tuner (or a broadcasting receiver), an HDMI port, a display port (DP), a digital visual interface (DVI) port, etc.

The electronic device 100 may include all types of devices for performing functions by including a processor and a memory. The electronic device 100 may include a stationary device or a portable device. For example, the electronic device 100 may indicate a device including a display and displaying image content, video content, game content, graphics content, etc. The electronic device 100 may include, for example, various types of electronic devices capable of receiving and outputting the content, such as televisions including a network TV, a smart TV, an Internet TV, a web TV, and an Internet protocol television (IPTV), computers including a desktop, a laptop, and a tablet, and various smart devices including a smartphone, a cellular phone, a game player, a music player, a video player, medical equipment, a home appliance, etc.

The block diagram of the electronic device 100 illustrated in FIG. 2 is a block diagram according to an example embodiment of the disclosure. Each component of the block diagram may be integrated, added, or omitted according to the disclosure of the actually realized electronic device 100. For example, two or more components may be integrated into one component, or one component may be divided into two or more components, according to necessity. A function executed in each block is to describe the various embodiments of the disclosure, and its specific operation or device does not limit the scope of the disclosure.

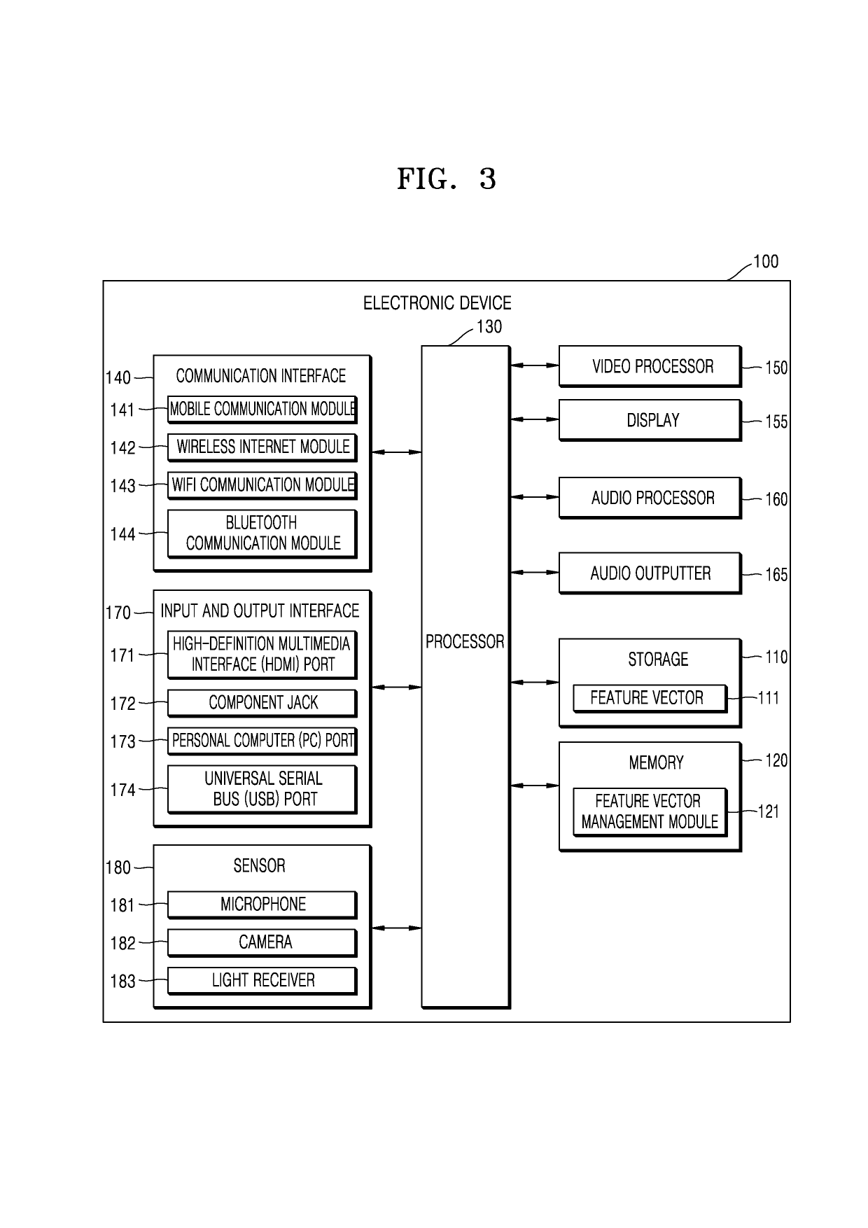

FIG. 3 is a block diagram illustrating an example configuration of the electronic device 100 according to various embodiments.

Referring to FIG. 3, the electronic device 100 may include the storage 110, the memory 120, the processor (e.g., including processing circuitry) 130, the communication interface (e.g., including communication circuitry) 140, a video processor (e.g., including video processing circuitry) 150, a display 155, an audio processor (e.g., including audio processing circuitry) 160, an audio outputter (e.g., including output circuitry) 165, an input and output interface (e.g., including input/output circuitry) 170, and a sensor 180.

The communication interface 140 may include various communication circuits included in one or more modules enabling wireless communication between the electronic device 100 and a wireless communication system or between the electronic device 100 and a network in which another electronic device is arranged. For example, the communication interface 140 may include a mobile communication module 141, a wireless Internet module 142, a WiFi communication module 143, and a Bluetooth communication module 144.

The mobile communication module 141 may transceive a wireless signal with at least one of a base station, an external terminal, or a server, on a mobile communication network. The wireless signal may include a sound call signal, a video-telephony call signal, or various forms of data based on transmission and reception of text/multimedia.

The wireless Internet module 142 may refer to a module for wireless Internet connection and may be embedded in a device or provided as an external component of the device. With respect to wireless Internet techniques, wireless local area network (WLAN) (or WiFi), wireless broadband (Wibro), world interoperability for microwave access (Wimax), high speed downlink packet access (HSDPA), etc. may be used. Through the wireless Internet module 142, the electronic device 100 may form WiFi peer to peer (P2P) connection with another electronic device.

The communication interface 140 may include a short-range wireless communication module for short-range wireless communication. With respect to short-range wireless communication techniques, Bluetooth, BLE, RFID, infrared data association (IrDA), UWB, Zigbee, etc. may be used. The communication interface 140 may include a WiFi communication module 113 and a Bluetooth communication module 144 as short-range wireless communication modules.

The WiFi communication module 143 may establish communication connection and perform communication according to WiFi communication protocols according to control by the processor 130.

The Bluetooth communication module 144 may establish communication connection and perform communication according to Bluetooth communication protocols according to control by the processor 130.

The display 155 may include a display panel and display an image signal on a screen.

The memory 120 may store a program related to the operations of the electronic device 100 and various data generated during the operations of the electronic device 100.

The memory 120 may store at least one instruction. The memory 120 may store at least one instruction executed by the processor 130. The memory 120 may store at least one program executed by the processor 130. The memory 120 may store an application for providing a specified service.

For example, the memory 120 may include at least one type of storage medium from among a flash memory type, a hard disk type, a multimedia card micro type, a card type memory (e.g., an SD or an XD memory), RAM, SRAM, ROM, EEPROM, PROM, a magnetic memory, a magnetic disk, and an optical disk.

The processor 130 may include various processing circuitry and control the overall operations of the electronic device 100. For example, the processor 130 may be configured to execute one or more instructions stored in the memory 120 to cause the electronic device 100 to perform the function described herein.

According to an embodiment of the disclosure, the processor 130 may store one or more instructions in an internal memory provided in the processor 130 and may be configured to execute the one or more instructions stored in the internal memory to control the operations of the electronic device 100 to be performed. That is, the processor 130 may be configured to execute at least one instruction or program stored in the internal memory of the processor 130 or the memory 120 to perform a specified operation.

According to an embodiment of the disclosure, the processor 130 may be configured to execute one or more instructions stored in the memory 120 to cause the electronic device 100 to perform the operations described herein.

The video processor 150 may include various circuitry and, under control of the processor 130, process an image signal received from the communication interface 140 and output the processed image signal to the display 155.

The audio processor 160 may include various circuitry and, under control of the processor 130, convert the audio signal received from the receiver 170 or the communication interface 140 into an analog audio signal and may output the analog audio signal to the audio outputter 165.

The audio outputter 165 may include various circuitry and output audio (for example, a voice or sound) input through the communication interface 140 or the input and output interface 170. The audio outputter 165 may output audio stored in the memory 120, according to control by the processor 130. The audio outputter 165 may include at least one or a combination of a speaker, a headphone output terminal, or a Sony/Philips digital interface (S/PDIF) output terminal.

The input and output interface 170 may include various circuitry and receive video (for example, a motion picture, etc.), audio (for example, a voice, music, etc.), and additional data (for example, an electronic program guide (EPG), etc.) from the outside of the electronic device 100, under control of the processor 130. The input and output interface 170 may include one or a combination of at least two of an HDMI port 171, a component jack 172, a PC port 173, and a USB port 174. The input and output interface 170 may further include a DP, Thunderbolt, and a mobile high-definition link (MHL), in addition to the HDMI port.

The sensor 180 may include at least one sensor and sense a voice, an image, or an interaction of a user and may include a microphone 181, a camera 182, and a light receiver 183.

The microphone 181 may receive a voice utterance of the user. The microphone 181 may convert the received voice into an electrical signal and may output the electrical signal through the processor 130. The user voice may include, for example, a voice corresponding to a menu or a function of the electronic device 100.

The camera 182 may receive an image (for example, consecutive frames) corresponding to a motion of a user including a gesture within a camera recognition range.

The light receiver 183 may receive a light signal (including a control signal) received from an external controlling device. The light receiver 183 may receive, from the controller, the light signal corresponding to a user input (for example, a touch input, a press input, a touch gesture, a voice, or a motion). A control signal may be extracted from the received light signal according to control by the processor 130.

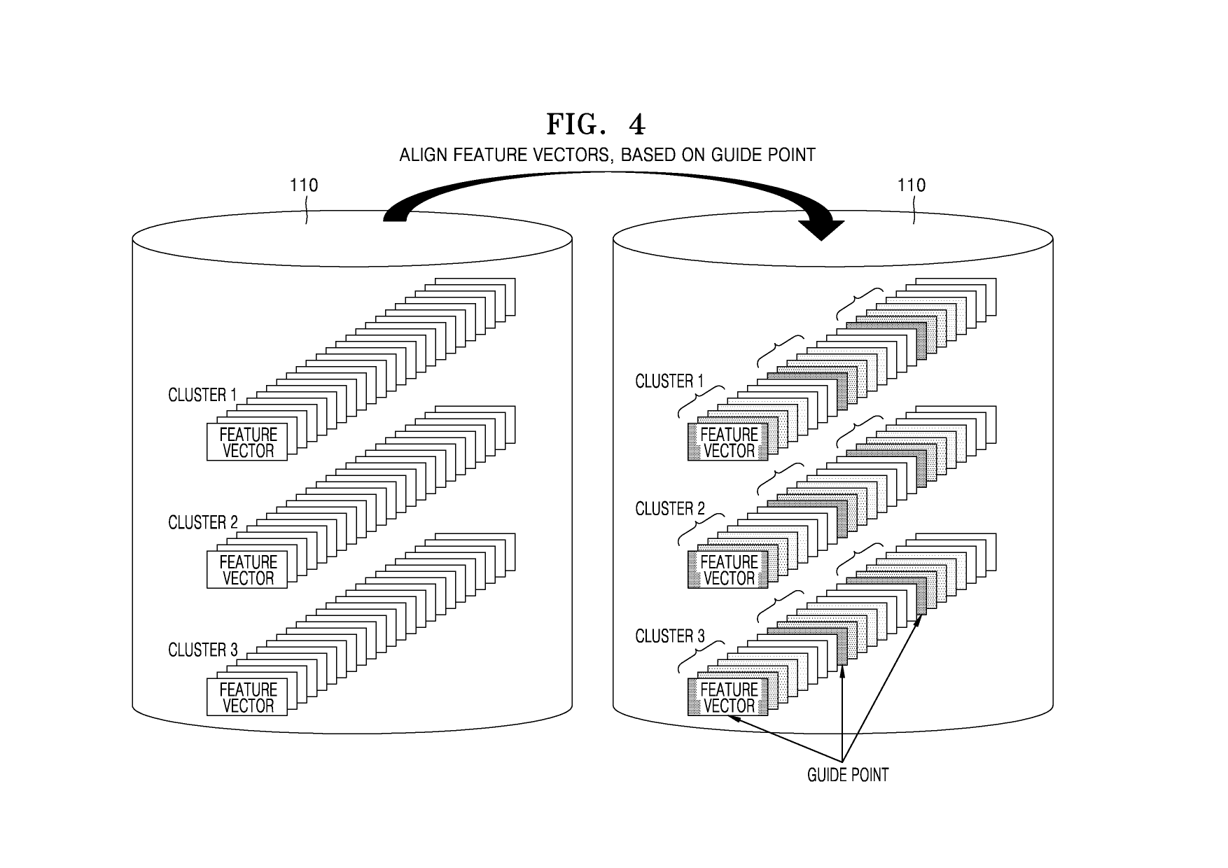

FIG. 4 is a diagram describing an example arrangement of a feature vector stored in the storage according to various embodiments.

Referring to FIG. 4, the electronic device 100 may store the feature vectors stored in the storage 110 by aligning the feature vectors stored in the storage 110, based on a guide point.

A vector may indicate all types of data including amorphous data, such as text, image, audio, video, etc. In general, a vector is represented by an array or a list of numbers, and each number of the list may indicate a specific function or attribute of corresponding data. For example, assuming that there is a set of a large quantity of cat pictures, each image is part of the amorphous data. However, a feature, such as an average color, a color histogram, a texture histogram, or whether (or not) there is an ear, whiskers, a tail, etc., may be extracted from each image to represent the image as a vector. Vector embedding or vectorization is a process of converting these features, etc. into numbers, and each data point may be represented as a vector in a high dimensional space.

As the vectors are arrayed in a multi-dimensional vector space, data points having similar attributes or features may naturally pull each other to form a cluster. For example, a trained convolutional neural network (CNN) may closely cluster dog images from a data set full of animal images and may separate the cluster of dog images from a cluster of cats or birds.

A feature vector may indicate a high dimensional representation of information called a visual explainer or, simply, an explainer. For example, an n-dimensional feature vector may indicate a vector including n number values indicating unique features related to some data sets, respectively. Thus, the dimension of the feature vector may indicate the number of unique values or features included in the feature vector.

For example, a visual computing application may often represent an object or an operation captured in visual data such as an image and/or a video using a high-dimensional feature vector. For example, the n-dimensional feature vector used to represent a particular object may include n number values indicating n unique features of the object. The high-dimensional feature vector may often be extracted from an image and a video and designated a label (e.g.: designated or tag-designated as belonging to a particular class) and may be formed as an index used for easily performing a subsequent operation. For example, by searching the feature vectors designated a label, a class of a feature vector not designated a label extracted from a new image or video may be identified.

For example, in relation to facial recognition, the feature vector may be used to represent faces of people captured in an image and/or a video. The feature vector may be generally extracted from visual data (e.g., an image and/or a video) using a specified feature extraction technique. For example, according to various embodiments of the disclosure, each value in an n-dimensional feature vector may indicate a unique feature related to the visual data with respect to a face of a particular person. For example, the feature vector may include 100 or more dimensions indicating 100 or more corresponding features extracted from the visual data with respect to a face of the corresponding person.

The electronic device 100 may extract a feature from data, such as an image, a video, etc., stored in the storage 110 and vectorize the extracted feature to generate a feature vector corresponding to each image or video. Also, the electronic device 100 may group the feature vectors into one or more clusters, by classifying the feature vectors according to a specified reference. The classification may be performed based on various references according to a usage or purpose of an application using the feature vector. For example, when photos of a user are classified according to places, a cluster corresponding to photos taken home, a cluster corresponding to photos taken by the sea, a cluster corresponding to photos taken in an office, and a cluster corresponding to photos taken in a restaurant may be generated.

The feature vectors included in these clusters classified according to specified references according to previous clustering are randomly arranged according to the corresponding clusters. Thus, to search for feature vectors corresponding to a specified target feature vector, the electronic device 100 may have to perform a search operation on all clusters included in a feature vector space and all feature vectors in each of the clusters. However, as the number of feature vectors included in the feature vector space greatly increases, it may inevitably take a lot of time to search all of the feature vectors in the clusters.

Thus, according to an embodiment of the disclosure, the electronic device 100 may arrange the clustered feature vectors, that is, the feature vectors included in each of the clusters, to have an order according to a specified reference.

According to an embodiment of the disclosure, the electronic device 100 may determine a specified number of guide point feature vectors from among feature vectors included in a cluster and may align the feature vectors within the cluster in order of adjacency with respect to a distance to each determined guide point feature vector, and store the aligned feature vectors.

In the cluster, the specified number of guide point feature vectors may be determined by various methods. The guide point feature vector may be a value which may evenly indicate the feature vectors of the corresponding cluster. For example, the space of the cluster may be split into a specified number of regions, based on the center of the corresponding cluster, and, the guide point feature vector may be determined as a feature vector located farthest from the center of the cluster in each of the regions.

Referring to FIG. 4, the electronic device 100 may store the cluster in the storage 110 by aligning the feature vectors based on the guide point feature vector. Three (3) clusters may be stored in the storage 110 illustrated in FIG. 4, and a determined number of guide point feature vectors may be determined in each of the clusters. The feature vectors may be aligned in order of the feature vectors adjacent to the guide point feature vector. For example, in the case of cluster 3, three (3) guide point feature vectors may be determined, and the feature vectors may be aligned and stored in order of the feature vectors adjacent to each guide point feature vector. For example, in FIG. 4, as the feature vector is indicated to be shaded similarly to the guide point feature vector, the feature vector may be indicated to be similar to the guide point feature vector, and as the feature vector becomes less shaded, the feature vector may be indicated to have a less degree of similarly to the guide point feature vector.

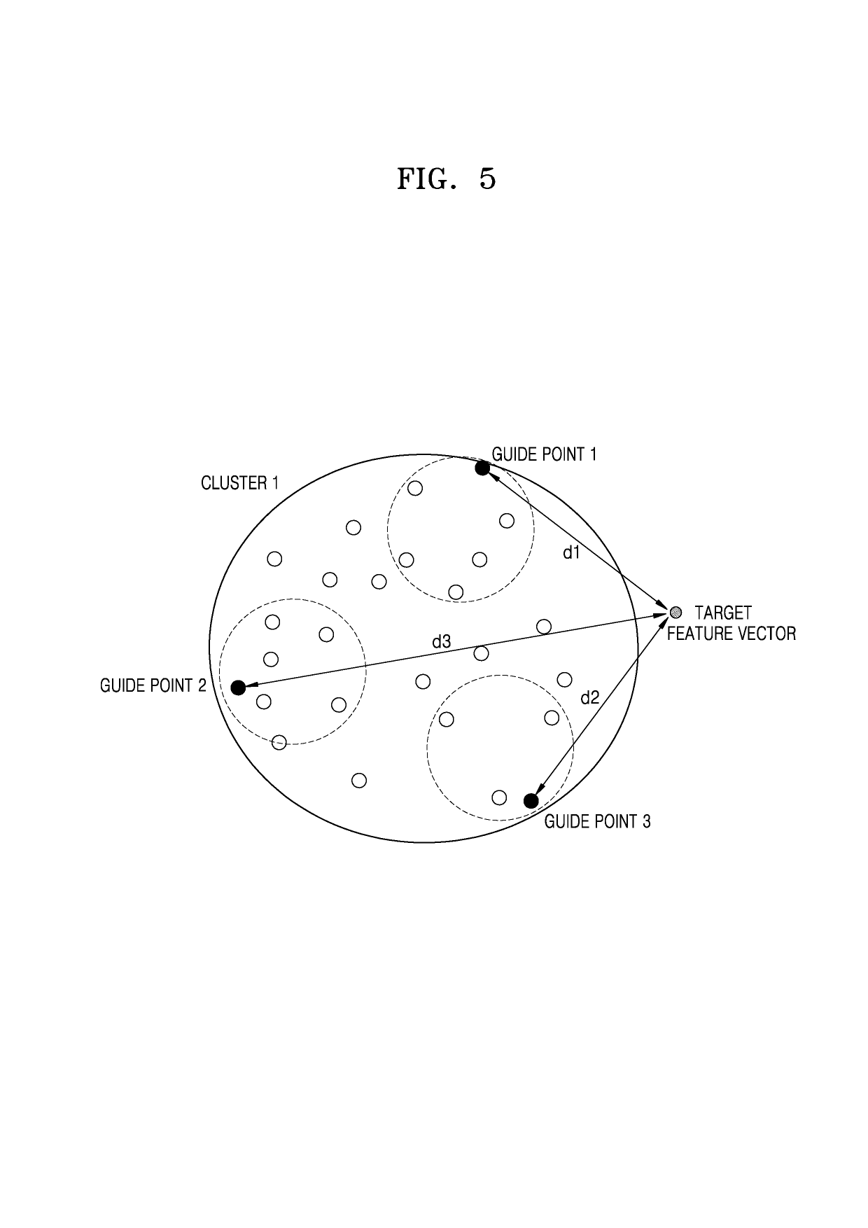

FIG. 5 is a diagram describing an example search method using a guide point feature vector, according to various embodiments.

Referring to FIG. 5, for example, cluster 1 may be designated three (3) guide point feature vectors, namely, guide point 1, guide point 2, and guide point 3. First, the electronic device 100 may calculate a distance between a queried target feature vector and each guide point and may perform a search in order of the guide point feature vectors adjacent to the target feature vector. In FIG. 5, it may be assumed that the distance between the target feature vector and the guide point 1 is the least as d1, next, the distance between the target feature vector and the guide point 3 is the second least as d2, and the distance between the target feature vector and the guide point 2 is the greatest as d3. In this case, the electronic device 100 may perform the search operation according to the order of adjacency, that is, the described order of the guide point 1, the guide point 3, and the guide point 2. For example, the electronic device 100 may first search for feature vectors similar to the target feature vector by measuring the similarity between the target feature vector and the feature vectors around guide point 1, in the order of the feature vectors aligned closer to guide point 1. For example, the electronic device 100 may perform the search operation on the feature vectors within a specified distance from the guide point 1. After the search for the feature vectors around the guide point 1 is completed, the electronic device 100 may search for feature vectors similar to the target feature vector by measuring the similarity between the target feature vector and the feature vectors around guide point 3, in the order of the feature vectors aligned closer to the second closest guide point 3 among the guide points. For example, the electronic device 100 may perform the search operation on the feature vectors within a specified distance from the guide point 3. After the search for the feature vectors around guide point 3 is completed, the electronic device 100 may search for feature vectors similar to the target feature vector by measuring the similarity between the target feature vector and the feature vectors around the last guide point 2, in the order of the feature vectors aligned closer to last guide point 2 among the guide points.

The electronic device 100 does not need to measure the similarity for all feature vectors in cluster 1. Instead, while searching in the order of guide points that are closer to the target feature vector, the electronic device 100 may output the similar feature vectors obtained during the search, once a certain proportion of the target feature vectors in the cluster has been searched, as result vectors. For example, the electronic device 100 may perform the calculation of the degree of similarity to the target feature vector on the feature vectors corresponding to 30 % of the entire feature vectors of the cluster, wherein the feature vectors corresponding to 30% may be determined based on the feature vectors adjacent to the guide point.

As described above, the electronic device 100 does not search all feature vectors within a cluster in a random order. Instead, using guide points, it identifies groups of feature vectors within the cluster that are close to the target feature vector, and calculates the distance between the target feature vector and the feature vectors in the identified group in the order of their proximity to the guide point. This allows the search order to be determined more efficiently, thereby significantly reducing the time required for the search.

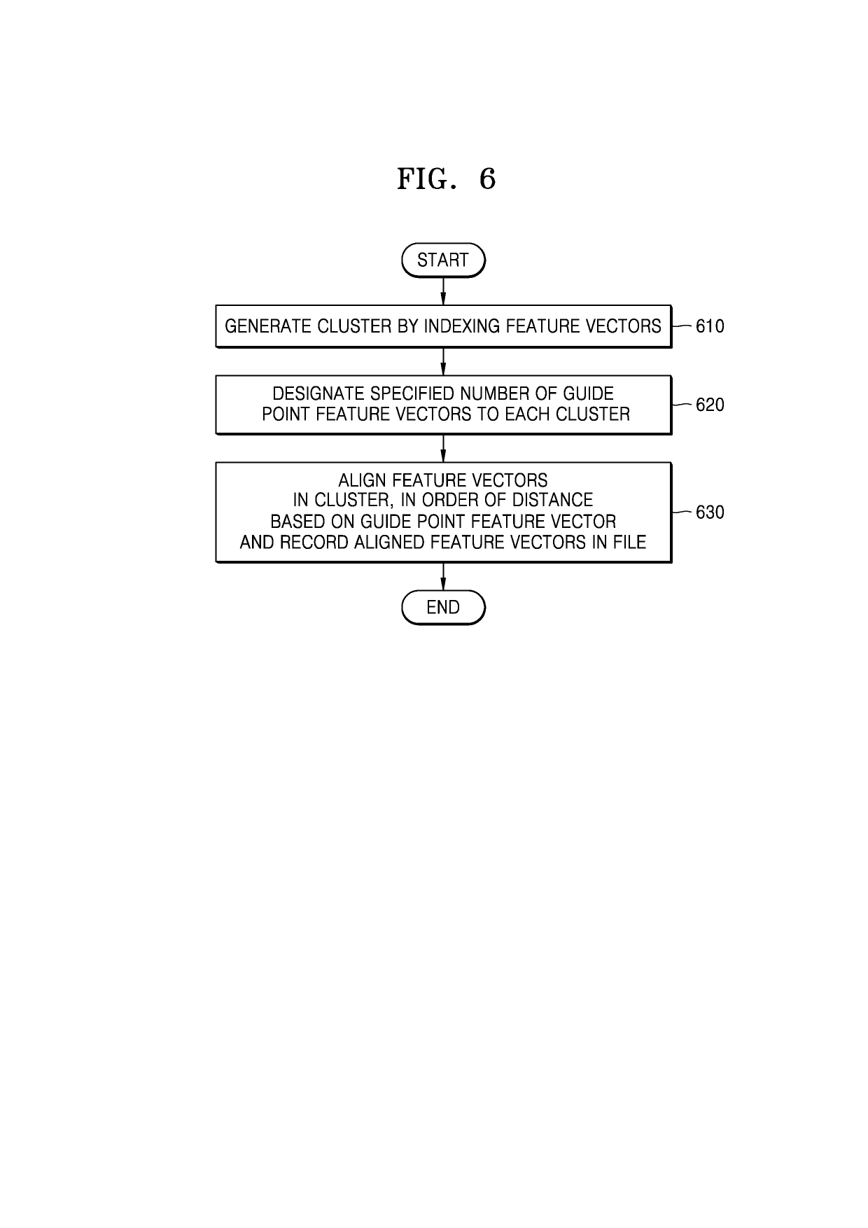

FIG. 6 is a flowchart illustrating an example method of operating the electronic device, according to various embodiments.

Referring to FIG. 6, in operation 610, the electronic device 100 may generate clusters by indexing feature vectors.

According to an embodiment of the disclosure, when the electronic device 100 receives input data, such as an image or a video, the electronic device 100 may extract a feature from the input data and may extract a feature vector including one or more feature values.

According to an embodiment of the disclosure, the electronic device 100 may classify the feature vectors according to a specified reference, and thus, may determine to which clusters the feature vectors belong. For example, when the electronic device generates five (5) clusters according to five (5) classification references, the electronic device 100 may determine to which one of the five (5) clusters a corresponding new feature vector belongs. This operation may be referred to as a labeling operation.

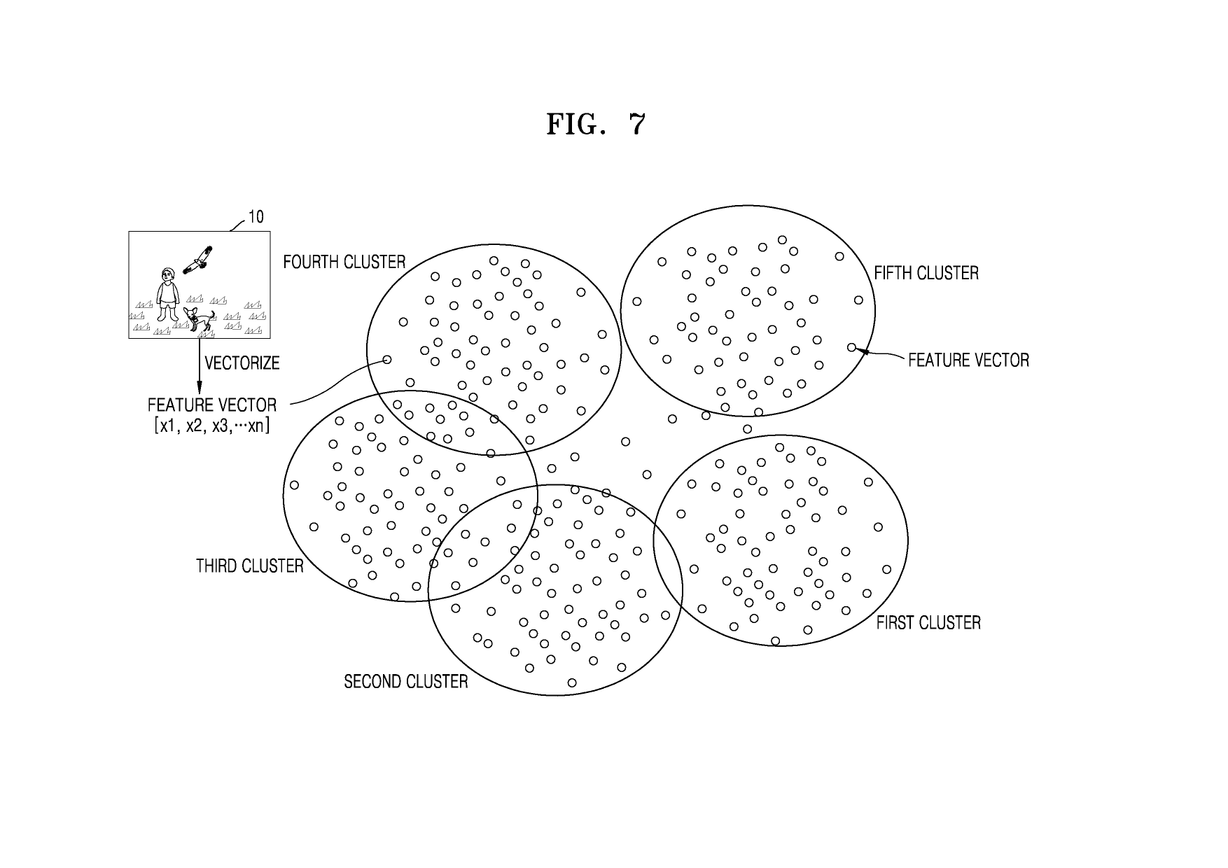

FIG. 7 is a diagram illustrating an example of a feature vector space according to various embodiments.

Referring to FIG. 7, when input data 10, such as a photo, etc., is obtained, the electronic device 100 may extract a feature vector by extracting and vectorizing a feature of the input data 10. Also, the electronic device 100 may classify the extracted feature vector according to a determined classification reference and may determine to which one of clusters the corresponding feature vector belongs. FIG. 7 illustrates that the cluster includes, for example, five (5) clusters.

Referring back to FIG. 6, in operation 620, the electronic device 100 may designate a determined (e.g., specified) number of guide points to each cluster.

According to an embodiment of the disclosure, the electronic device 100 may designate the determined number of guide points which may represent feature vectors included in each corresponding cluster, for each cluster. The guide point may be configured to identify the feature vectors included in each corresponding cluster, based on their values, and the number of guide points may be variously determined and methods of the determining may be variously selected.

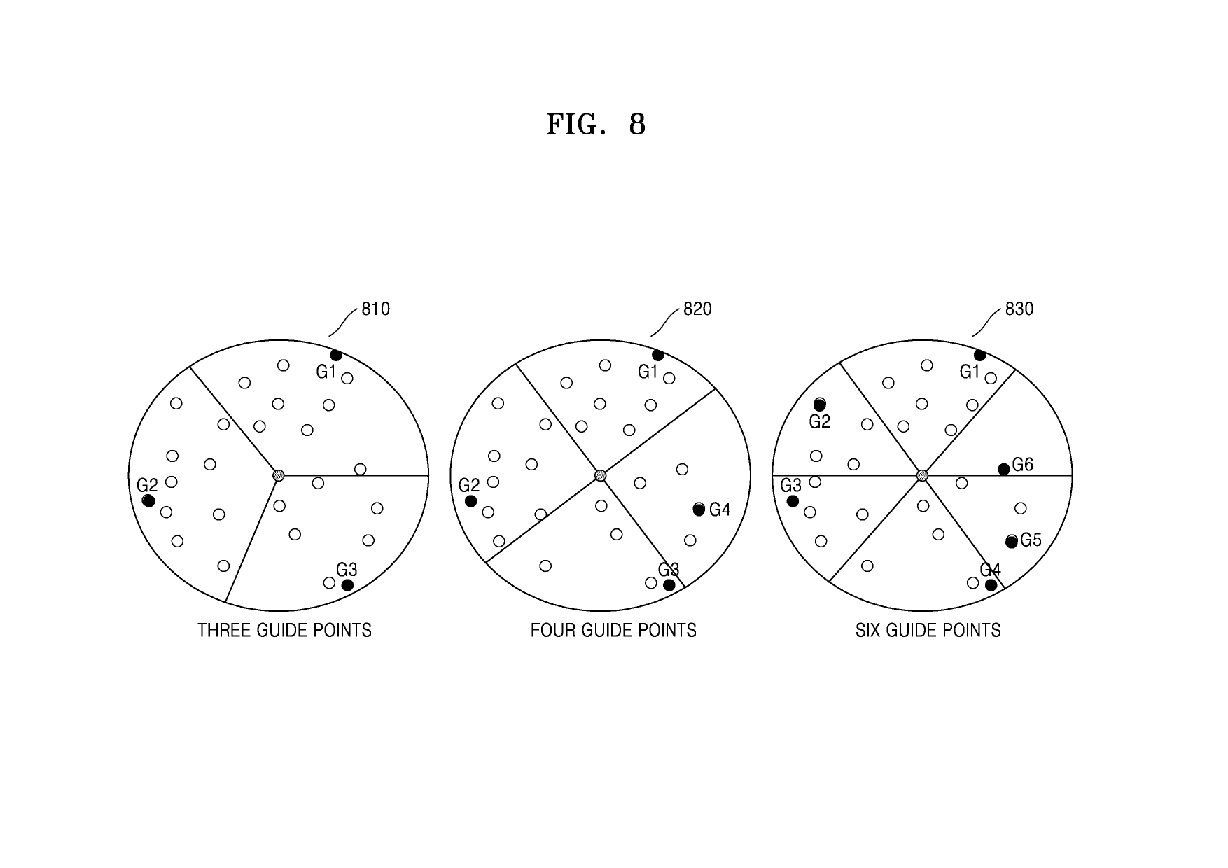

FIG. 8 is a diagram describing an example method of designating a guide point in a cluster according to various embodiments.

Referring to FIG. 8, in a case 810 where three (3) guide points are designated, the electronic device 100 may separate a space of feature vectors included in a cluster into three (3) regions, based on the center of the cluster, and may designate one feature vector in each region as the guide point. For example, the electronic device 100 may designate the feature vector in each region, the feature vector being located farthest from the center of the cluster, as the guide point. In the case 810, it is illustrated that guide points G1, G2, and G3 are designated. The center of the cluster may indicate the average of values of all feature vectors included in the cluster.

In a case 820 where four (4) guide points are designated, the electronic device 100 may separate a space of feature vectors included in a cluster into four (4) regions, based on the center of the cluster, and may designate one feature vector in each region as the guide point. For example, the electronic device 100 may designate the feature vector in each region, the feature vector being located farthest from the center of the cluster, as the guide point. In the case 820, it is illustrated that guide points G1, G2, G3, and G4 are designated.

In a case 830 where six (6) guide points are designated, the electronic device 100 may separate a space of feature vectors included in a cluster into six (6) regions, based on the center of the cluster, and may designate one feature vector in each region as the guide point. For example, the electronic device 100 may designate the feature vector in each region, the feature vector being located farthest from the center of the cluster, as the guide point. In the case 830, it is illustrated that guide points G1, G2, G3, G4, G5, and G6 are designated.

The number of guide points in the example illustrated in FIG. 8 is merely an example and may be variously determined.

In the example illustrated in FIG. 8, it is described that the regions in which the guide points are designated are separated based on the center of the cluster. However, it is not necessarily limited thereto and the regions may be determined by various methods of separating the space.

In the example illustrated in FIG. 8, it is described that the guide point is designated as the feature vector in each region, the feature vector being farthest from the center of the cluster. However, the disclosure is not limited thereto. The guide point may also be determined based on the center of the feature vectors included in each region.

Referring back to FIG. 6, in operation 630, the electronic device 100 may align the feature vectors in each cluster according to a distance order with respect to the guide point feature vector and may record the feature vectors on a file.

According to an embodiment of the disclosure, the electronic device 100 may measure the similarity between the guide point feature vector and the feature vectors in the cluster and may identify the feature vectors adjacent to the guide point feature vector. Based on the guide point feature vector, the electronic device 100 may align the feature vectors in an order of the feature vectors adjacent to the guide point feature vector.

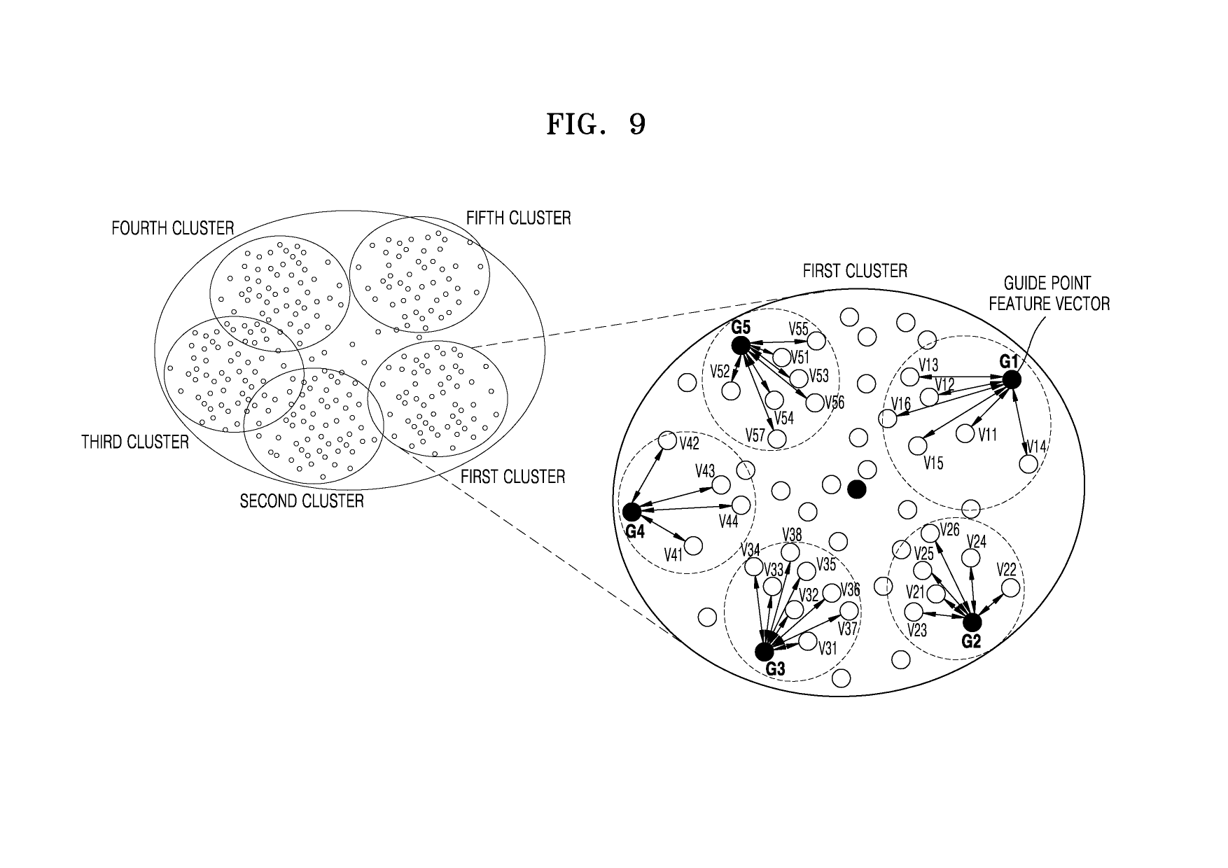

FIG. 9 is a diagram illustrating example feature vectors adjacent to a guide point according to various embodiments.

Referring to FIG. 9, according to an embodiment of the disclosure, a feature vector space may include five (5) clusters, for example, a first cluster, a second cluster, a third cluster, a fourth cluster, and a fifth cluster. The electronic device 100 may designate each cluster a guide point feature vector. For example, the electronic device 100 may designate five (5) guide points G1, G2, G3, G4, and G5 to the first cluster. Also, the feature vectors located adjacent to each guide point may be identified. For example, V11, V12, V13, V14, V15, and V16 may be identified in the order of adjacency to the guide point G1. For example, V21, V22, V23, V24, V25, and V26 may be identified in the order of adjacency to the guide point G2. For example, V31, V32, V33, V34, V35, V36, V37, and V38 may be identified in the order of adjacency to the guide point G3. For example, V41, V42, V43, and V44 may be identified in the order of adjacency to the guide point G4. For example, V51, V52, V53, V54, V55, V56, and V57 may be identified in the order of adjacency to the guide point G5.

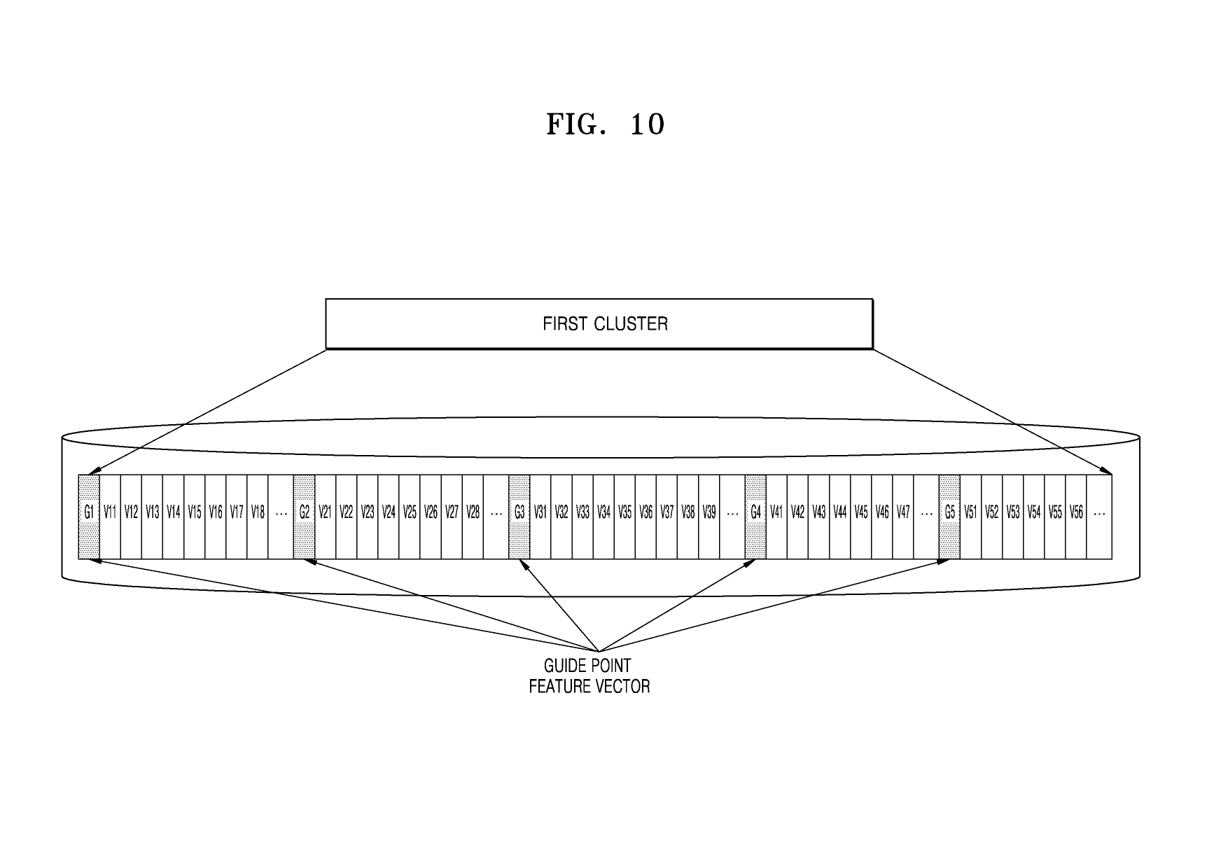

FIG. 10 is a diagram illustrating an example of a feature vector file stored in a storage according to various embodiments.

Referring to FIG. 10, according to an embodiment of the disclosure, the electronic device 100 may store feature vectors included in the cluster such that the feature vectors are aligned based on the guide points as described with reference to FIG. 9, rather than arbitrarily arranging the feature vectors. For example, the electronic device 100 may label five (5) guide point feature vectors included in the first cluster as the guide points and may align and record the feature vectors in order of the feature vectors adjacent to each guide point. For example, the feature vectors V11, V12, V13, V14, V15, and V16 may be recorded in the order of adjacency to the guide point G1, the feature vectors V21, V22, V23, V24, V25, and V26 may be recorded in the order of adjacency to the guide point G2, the feature vectors V31, V32, V33, V34, V35, V36, V37, and V38 may be recorded in the order of adjacency to the guide point G3, the feature vectors V41, V42, V43, and V44 may be recorded in the order of adjacency to the guide point G4, and the feature vectors V51, V52, V53, V54, V55, V56, and V57 may be recorded in the order of adjacency to the guide point G5.

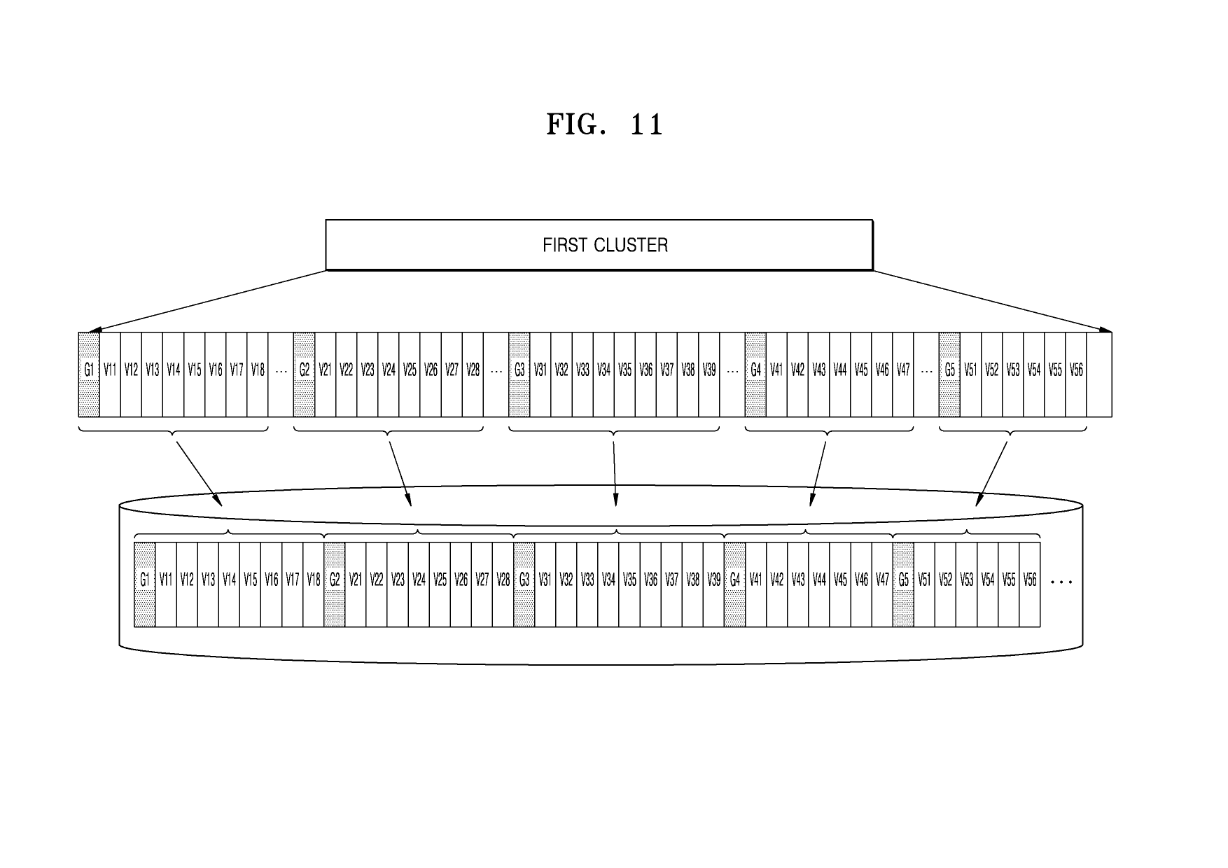

FIG. 11 is a diagram illustrating an example of a feature vector file stored in a storage according to various embodiments.

Referring to FIG. 11, according to an embodiment of the disclosure, the electronic device 100 may store feature vectors included in the cluster such that the feature vectors are aligned based on the guide points as described with reference to FIG. 9, rather than arbitrarily arranging the feature vectors. For example, the electronic device 100 may label five (5) guide point feature vectors included in the first cluster as the guide points and may align and record the feature vectors in order of the feature vectors adjacent to each guide point. For example, the feature vectors V11, V12, V13, V14, V15, V16, V17, and V18 may be recorded in the order of adjacency to the guide point G1, the feature vectors V21, V22, V23, V24, V25, V26, V27, and V28 may be recorded in the order of adjacency to the guide point G2, the feature vectors V31, V32, V33, V34, V35, V36, V37, V38, and V39 may be recorded in the order of adjacency to the guide point G3, the feature vectors V41, V42, V43, V44, V45, V46, and V47 may be recorded in the order of adjacency to the guide point G4, and the feature vectors V51, V52, V53, V54, V55, and V56 may be recorded in the order of adjacency to the guide point G5. Thereafter, the remaining feature vectors of the first cluster may be recorded.

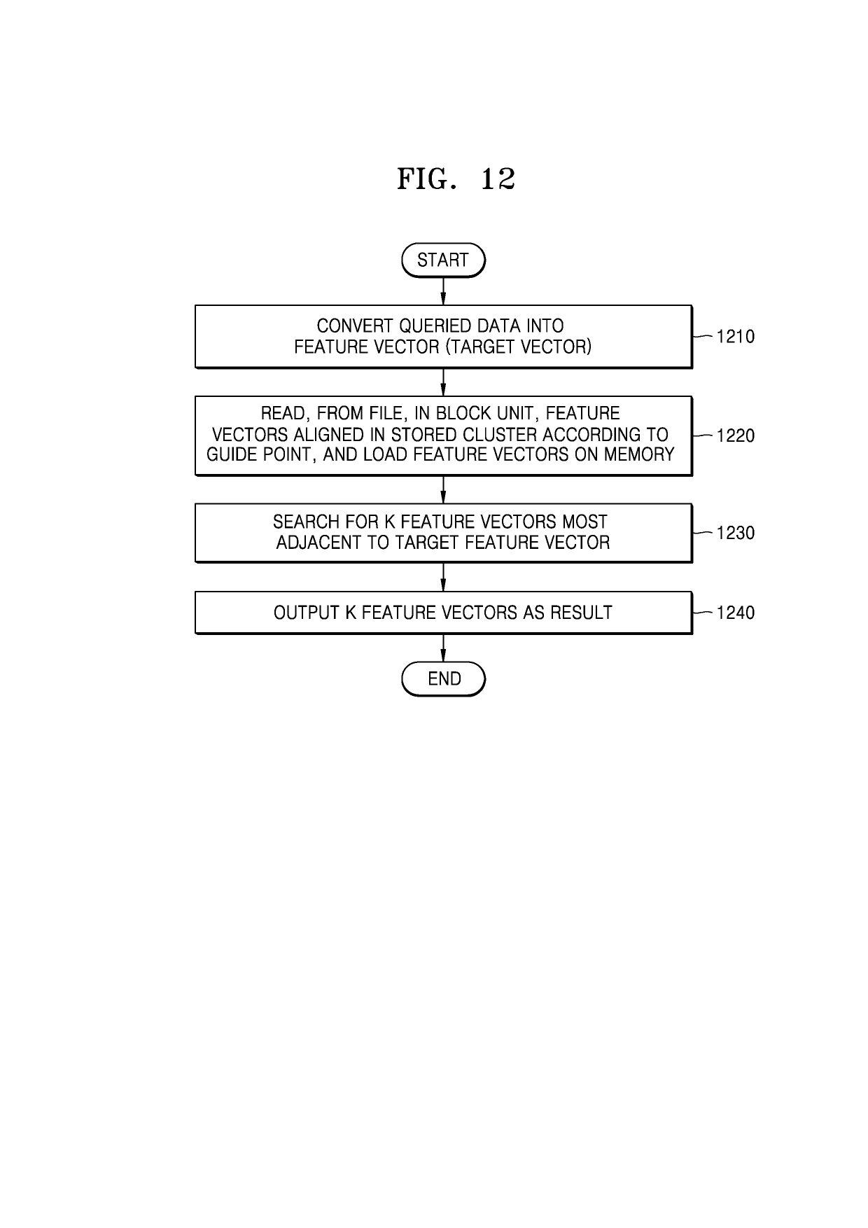

FIG. 12 is a flowchart illustrating an example method of searching feature vectors based on a guide point, according to various embodiments.

Referring to FIG. 12, in operation 1210, the electronic device 100 may convert queried data into a feature vector, that is, a target feature vector.

In operation 1220, the electronic device 100 may read, from a cluster stored in the storage, and load, on the memory, the feature vectors aligned according to the guide point, in a block unit. The block unit may denote a size of a data block loaded on the memory from a file stored in the storage, at a time.

In operation 1230, the electronic device 100 may search for k feature vectors most adjacent to the target feature vector.

In operation 1240, the electronic device 100 may output the k feature vectors as results.

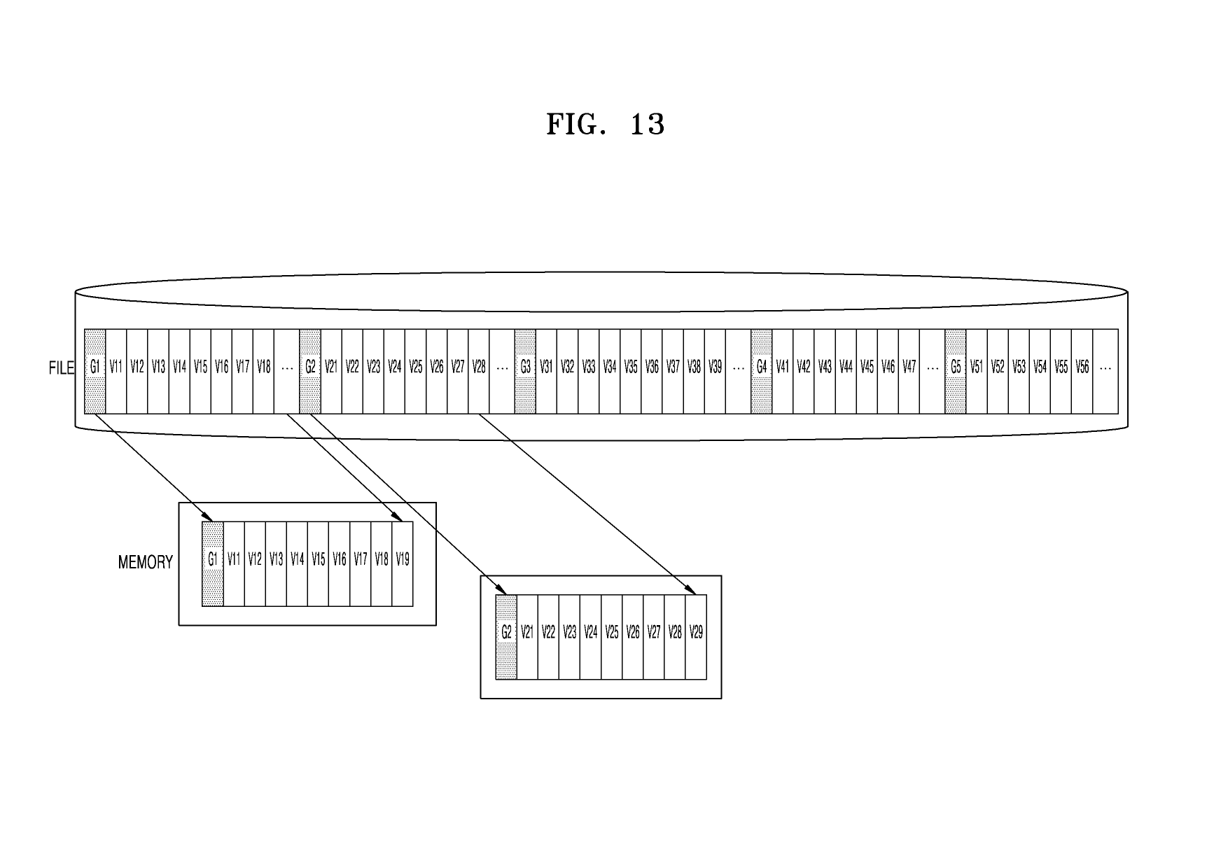

FIG. 13 is a diagram illustrating an example of a block loaded on a memory from a file according to various embodiments.

Referring to FIG. 13, in the storage, based on the guide point, the feature vectors in each cluster may be aligned and recorded in the order of feature vectors adjacent to the guide point as illustrated in FIG. 10. In this case, when the block size loaded on the memory from the storage by the electronic device 100 corresponds to the size of ten (10) feature vectors, the electronic device 100 may load G1 to V19 in a first loading operation. The electronic device 100 may calculate similarity between the target feature vector and the feature vectors G1 to V19 loaded on the memory and may obtain a similar feature vector. When similarity for all of the feature vectors included in the first loaded block are calculated, the electronic device 100 may load G2 to V29 in a second loading operation. The electronic device 100 may not have to calculate the similarity for all feature vectors aligned based on a guide point G1. When a specified ratio or higher of the feature vectors aligned based on the guide point G1 is searched, the electronic device 100 may proceed to search the feature vectors aligned based on a next guide point G2. For example, when the specified ratio is determined to be 30%, the electronic device 100 may proceed to search the feature vectors aligned based on the guide point G2, when 30% of the feature vectors aligned based on the guide point G1 is searched. As described above, the search operation may not be performed on all of the feature vectors in the cluster according to an arbitrary order. According to an embodiment of the disclosure, some feature vectors aligned based on the guide point may be searched, and thus, time for the search operation may be significantly reduced.

The electronic device 100 may not have to load and search all the feature vectors aligned based on all the guide points. When the search is completed on feature vectors of a specified ratio or higher, the electronic device 100 may not continually perform the search. For example, when the search operation with respect to up to the feature vectors aligned based on a guide point G4 is completed, and when a satisfactory feature vector is found, for example, when a desired number of resultant feature vectors are found, the electronic device 100 may not have to continually load the feature vectors aligned based on a guide point G5.

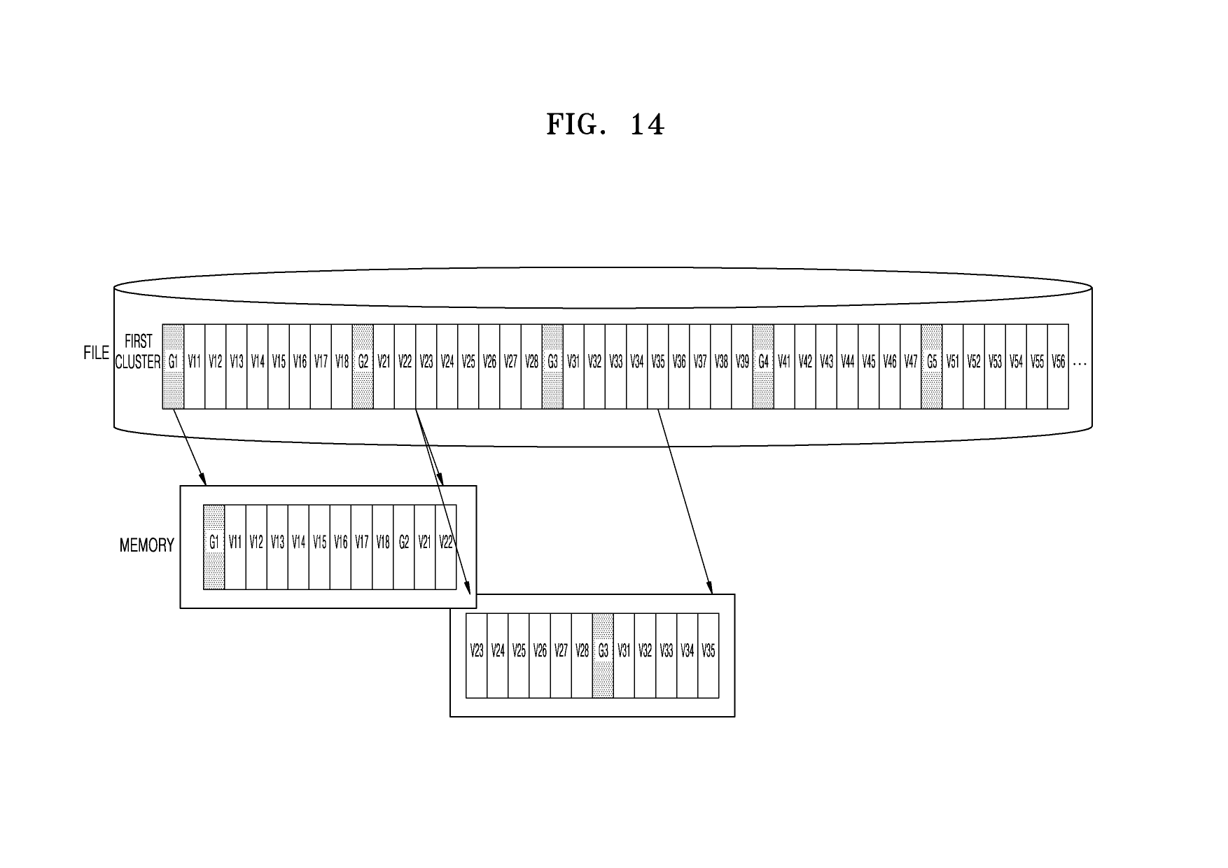

FIG. 14 is a diagram illustrating an example of a block loaded on a memory from a file according to various embodiments.

Referring to FIG. 14, as shown in FIG. 11, the feature vectors of each cluster are recorded in the storage in the order of proximity to the guide point, based on the guide point. The feature vectors may be recorded in advance in the order of a specified number of closest feature vectors. In this case, when the block size loaded on the memory from the storage by the electronic device 100 corresponds to the size of twelve (12) feature vectors, the electronic device 100 may load G1 to V22 in a first loading operation. The electronic device 100 may calculate similarity between the target feature vector and the feature vectors G1 to V22 loaded on the memory and may obtain a similar feature vector. When the similarity for all of the feature vectors included in the first loaded block are calculated, the electronic device 100 may load V23 to V35 in a second loading operation. In the example illustrated in FIG. 14, the feature vectors adjacent to each guide point are not recorded all at once in continuous sequence. Instead, a specified number of feature vectors adjacent to a specific guide point are sorted and recorded, followed by a sorted recording of a specified number of feature vectors adjacent to the next guide point. This allows the electronic device 100 to more easily identify the location of the next block to be loaded.

According to an example embodiment of the disclosure, an electronic device may include memory storing one or more instructions and at least one processor, wherein at least one processor, individually and/or collectively, may be configured to execute the one or more instructions and cause the electronic device to: obtain a cluster including a plurality of feature vectors, in which a specified number of guide point feature vectors are defined from among the plurality of feature vectors and the feature vectors are arranged in order of feature vectors adjacent to each guide point feature vector, obtain a target feature vector corresponding to queried input data, identify a first guide point feature vector corresponding to the target feature vector, and obtain a resultant feature vector by searching the feature vectors in order of the feature vectors adjacent to the first guide point feature vector.

According to an example embodiment of the disclosure, at least one processor, individually and/or collectively, may be configured to cause the electronic device to designate a specified number of feature vectors farthest from a center of the cluster as the guide point feature vectors, and align the feature vectors within the cluster in order of distance from the guide point feature vector and record the aligned feature vectors in a storage.

According to an example embodiment of the disclosure, at least one processor, individually and/or collectively, may be configured to cause the electronic device to split a feature vector space into a specified number of regions, based on a center of the feature vector space of the cluster and designate one guide point feature vector to each of the specified number of regions.

According to an example embodiment of the disclosure, at least one processor, individually and/or collectively, may be configured to cause the electronic device to load, from the storage, on the memory, a block of the feature vectors in units of a specified block size, in order of the feature vectors adjacent to the guide point feature vector, and obtain one or more feature vectors adjacent to the target feature vector, by calculating degrees of similarity between the feature vectors and the target feature vector, in order of the feature vectors adjacent to the guide point feature vector in the loaded block.

According to an example embodiment of the disclosure, a method of operating an electronic device may include: obtaining a cluster including a plurality of feature vectors, in which a specified number of guide point feature vectors are defined from among the plurality of feature vectors and the feature vectors are arranged in order of feature vectors adjacent to each guide point feature vector, obtaining a target feature vector corresponding to queried input data, identifying a first guide point feature vector corresponding to the target feature vector, and obtaining a resultant feature vector by searching the feature vectors in order of the feature vectors adjacent to the first guide point feature vector.

According to an example embodiment of the disclosure, the method may further include designating a specified number of feature vectors farthest from a center of the cluster as the guide point feature vectors and aligning the feature vectors within the cluster in order of distance from the guide point feature vector and recording the aligned feature vectors in a storage.

According to an example embodiment of the disclosure, the method may further include splitting a feature vector space into a specified number of regions, based on a center of the feature vector space of the cluster and designating one guide point feature vector to each of the specified number of regions.

According to an example embodiment of the disclosure, the method may further include loading, from the storage, on a memory, a block of the feature vectors in units of a specified block size, in order of the feature vectors adjacent to the guide point feature vector, and obtaining one or more feature vectors adjacent to the target feature vector, by calculating degrees of similarity between the feature vectors and the target feature vector, in order of the feature vectors adjacent to the guide point feature vector in the loaded block.

According to an example embodiment of the disclosure, a non-transitory computer-readable recording medium may have stored thereon one or more instructions which, when executed by at least one processor, comprising processing circuitry, individually and/or collectively, of an electronic device, cause the electronic device to: obtain a cluster including a plurality of feature vectors, in which a specified number of guide point feature vectors are defined from among the plurality of feature vectors and the feature vectors are arranged in order of feature vectors adjacent to each guide point feature vector, obtain a target feature vector corresponding to queried input data, identify a first guide point feature vector corresponding to the target feature vector, and obtain a resultant feature vector by searching the feature vectors in order of the feature vectors adjacent to the first guide point feature vector.

One or more embodiments of the disclosure may be realized as a recording medium including a computer-executable instruction, such as a program module executed by a computer. A computer-readable medium may include an arbitrary available medium accessible by a computer and includes all of a volatile medium, a non-volatile medium, a detachable medium, and a non-detachable medium. The computer-readable medium may include a computer storage medium. The computer storage medium may include all of a volatile medium, a non-volatile medium, a detachable medium, and a non- detachable medium realized by an arbitrary method or technique for storing a computer-readable instruction, a data structure, a program module, or information such as other data.

The various example embodiments of the disclosure may be realized as a software (S/W) program including an instruction stored in a computer-readable storage medium.

A computer may include a device for calling the instruction stored in the storage medium and performing, according to the called instruction, operations according to an embodiment of the disclosure and may include the electronic device 100 according to embodiments of the disclosure.

The computer-readable storage medium may include a non-transitory storage medium. Here, the "non-transitory" storage medium may not include a signal and may be tangible.

The method of operating the electronic device according to various example embodiments of the disclosure may be included in a computer program product. The computer program product may be transacted between a seller and a purchaser as a product.

The computer program product may include an S/W program or a computer-readable storage medium storing an S/W program. For example, the computer program product may include a product in the form of an S/W program (for example, a downloadable application) that is electronically distributed through a manufacturer of a device or an electronic market (for example, a Google play store or an App store). For electronic distribution, at least a part of the S/W program may be stored in a storage medium or temporarily generated. In this case, the storage medium may include a server of a manufacturer, a server of an electronic market, or a storage medium of a relaying server temporarily storing the S/W program.

In a system including a server and a device, the computer program product may include a storage medium of the server or a storage medium of the device. Alternatively, when there is a third device (for example, a smartphone) connected to the server or the device for communication, the computer program product may include a storage medium of the third device. Alternatively, the computer program product may include an S/W program itself transmitted from the server to the device or the third device or transmitted from the third device to the device.

In this case, any one of the server, the device, and the third device may execute the computer program product to perform the method according to embodiments of the disclosure. Alternatively, at least two of the server, the device, and the third device may execute the computer program product to perform the method according to embodiments of the disclosure in a distributed fashion.

For example, the server (for example, a cloud server or an artificial intelligence (AI) server) may execute the computer program product stored in the server so that a device connected to the server for communication may be controlled to perform the method according to embodiments of the disclosure.

As another example, the third device may execute the computer program product so that the device connected to the third device for communication may be controlled to perform the method according to embodiments of the disclosure. When the third device executes the computer program product, the third device may download the computer program product from the server and execute the downloaded computer program product. Alternatively, the third device may execute the computer program product provided in a pre-loaded state and may perform the method according to embodiments of the disclosure.

In the disclosure, a "unit" may refer to a hardware component, such as a processor or a circuit, and/or an S/W component executed by the hardware component, such as the processor.

While the disclosure has been illustrated and described with reference to various example embodiments, it will be understood that the various example embodiments are intended to be illustrative, not limiting. It will be further understood by those skilled in the art that various modifications, alternatives and/or variations of the various example embodiments may be made without departing from the true technical spirit and full technical scope of the disclosure, including the appended claims and their equivalents. It will also be understood that any of the embodiment(s) described herein may be used in conjunction with any other embodiment(s) described herein.

What is claimed is:

1. An electronic device comprising:
memory storing one or more instructions; and
at least one processor comprising processing circuitry,
wherein at least one processor, individually and/or collectively, is configured to execute the one or more instructions and to cause the electronic device to:
obtain a cluster comprising a plurality of feature vectors, in which a specified number of guide point feature vectors are defined from among the plurality of feature vectors and the feature vectors are arranged in order of feature vectors adjacent to each guide point feature vector;
obtain a target feature vector corresponding to queried input data;
identify a first guide point feature vector corresponding to the target feature vector; and
obtain a resultant feature vector by searching the feature vectors in order of the feature vectors adjacent to the first guide point feature vector.

2. The electronic device of claim 1, wherein at least one processor, individually and/or collectively, is configured to cause the electronic device to:
designate a specified number of feature vectors farthest from a center of the cluster as the guide point feature vectors; and
align the feature vectors within the cluster in order of distance from the guide point feature vector and record the aligned feature vectors in a storage.

3. The electronic device of claim 1, wherein at least one processor, individually and/or collectively, is configured to cause the electronic device to:
split a feature vector space into a specified number of regions, based on a center of the feature vector space of the cluster; and
designate one guide point feature vector to each of the specified number of regions.

4. The electronic device of claim 1, wherein at least one processor, individually and/or collectively, is configured to cause the electronic device to:
load, from the storage, on the memory, a block of the feature vectors in units of a specified block size, in order of the feature vectors adjacent to the guide point feature vector; and
obtain one or more feature vectors adjacent to the target feature vector, by calculating degrees of similarity between the feature vectors and the target feature vector, in order of the feature vectors adjacent to the guide point feature vector in the loaded block.

5. A method for operating an electronic device, the method comprising:
obtaining a cluster comprising a plurality of feature vectors, in which a specified number of guide point feature vectors are defined from among the plurality of feature vectors and the feature vectors are arranged in order of feature vectors adjacent to each guide point feature vector;
obtaining a target feature vector corresponding to queried input data;
identifying a first guide point feature vector corresponding to the target feature vector; and
obtaining a resultant feature vector by searching the feature vectors in order of the feature vectors adjacent to the first guide point feature vector.

6. The method of claim 5, further comprising:
designating a specified number of feature vectors farthest from a center of the cluster as the guide point feature vectors; and
aligning the feature vectors within the cluster in order of distance from the guide point feature vector and recording the aligned feature vectors in a storage.

7. The method of claim 5, further comprising:
splitting a feature vector space into a specified number of regions, based on a center of the feature vector space of the cluster; and
designating one guide point feature vector to each of the specified number of regions.

8. The method of claim 5, further comprising:
loading, from the storage, on a memory, a block of the feature vectors in units of a specified block size, in order of the feature vectors adjacent to the guide point feature vector; and
obtaining one or more feature vectors adjacent to the target feature vector, by calculating degrees of similarity between the feature vectors and the target feature vector, in order of the feature vectors adjacent to the guide point feature vector in the loaded block.

9. A non-transitory computer-readable recording medium having stored thereon one or more instructions which, when executed by at least one processor, comprising processing circuitry, individually and/or collectively, of an electronic device, cause the electronic device to:
obtain a cluster comprising a plurality of feature vectors, in which a specified number of guide point feature vectors are defined from among the plurality of feature vectors and the feature vectors are arranged in order of feature vectors adjacent to each guide point feature vector;
obtain a target feature vector corresponding to queried input data;
identify a first guide point feature vector corresponding to the target feature vector; and
obtain a resultant feature vector by searching the feature vectors in order of the feature vectors adjacent to the first guide point feature vector.
